(19) United States
(12) Patent Application Publication
(10) Pub. No.: US 2012/0213254 A1
(43) Pub. Date: Aug. 23, 2012

(54) COMMUNICATION CAPACITY EVALUATING APPARATUS, RADIO RELAY APPARATUS AND COMMUNICATION CAPACITY EVALUATING METHOD

(75) Inventors: Yasuo Yokouchi, Kanagawa (JP); Jun Imai, Kanagawa (JP); Tomoaki Shimizu, Kanagawa (JP); Yukinori Amao, Kanagawa (JP); Richol Ku, Kanagawa (JP); Takayuki Sotoyama, Kanagawa (JP)

(73) Assignee: PANASONIC CORPORATION, OSAKA (JP)

(21) Appl. No.: 13/504,408

(22) PCT Filed: Oct. 29, 2010
(86) PCT No.: PCT/JP2010/006395

§ 371 Date: Apr. 26, 2012

(30) Foreign Application Priority Data
Nov. 13, 2009 (JP) 2009-260222

(51) Int. Cl. H04W 24/00; H04B 7/06; H04W 88/04

(52) U.S. Cl. 375/213; 375/224

(57) ABSTRACT

Provided is a communication capacity evaluating apparatus whereby the communication capacity can be grasped and the necessity of changing the content of a dead spot measure after the placement of a relay apparatus can be eliminated. In the communication capacity evaluating apparatus, a system information analyzing unit (121) acquires, from a received signal, used-band information of the communication using a MIMO mode. An S/N calculating unit (122) analyzes the received signal to determine a signal-to-noise ratio. A channel estimating unit (123) analyzes the received signal to determine a channel matrix. A throughput limit calculating unit (124) calculates the limit value of the communication capacity on the basis of the used-band information, information about the number of transmission antennas of a base station (180), information about the number of reception antennas of a radio relay apparatus (100) stored in advance, the signal-to-noise ratio and the channel matrix. A display unit (133) displays the result of a comparison between the limit value and a desired value of communication capacity set in advance.

### TECHNICAL FIELD

The present invention relates to a communication capacity evaluating apparatus, a radio repeater apparatus, and a communication capacity evaluating method. More particularly, the present invention relates to a communication capacity evaluating apparatus, a radio repeater apparatus, and a communication capacity evaluating method, which learn communication capacity in a setting location of a radio repeater apparatus performing relay processing of communication using a multi-input multi-output (MIMO) scheme,

### BACKGROUND ART

Recently it has been required to set a repeater apparatus which enables communication using a MIMO scheme as countermeasures for blind zones in communication using a MIMO scheme which is one of next-generation communications. When setting the repeater apparatus, it is necessary to learn communication capacity (throughput) of communication using a. MIMO scheme in a setting location and set a repeater apparatus on condition that a certain amount of communication capacity can be secured.

Also, conventionally, it is known to determine a state of communication using a MIMO scheme (see, for example, Patent Literature 1). Patent Literature 1 discloses a state index calculating section that calculates a state index showing a current communication state using all or part of transfer functions, and a communication state display section that changes display contents according to a value of a state index.

### CITATION LIST

### Patent Literature

### PTL 1

### Japanese Patent Application Laid-Open No.2006-211566

### SUMMARY OF INVENTION

### Technical Problem

However, with Patent Literature 1, it is not possible to calculate communication capacity from a communication state index calculated from only a transfer function, and. therefore there is a problem that communication capacity cannot be learnt. Also, with Patent Literature 1, a limit value of communication capacity cannot be known even when a communication state index is displayed, and there is a problem that cannot determine whether or not it is appropriate as a setting location of a repeater apparatus. Also, with Patent Literature 1, since it is not possible to determine whether or not it is appropriate as a setting location, therefore, there is a problem that the contents of countermeasures for blind zones need to be changed upon finding that a limit value of communication capacity does not satisfy a desired value after the setting of the repeater apparatus.

It is therefore an object of the present invention to provide a communication capacity evaluating apparatus, a radio repeater apparatus, and a communication capacity evaluating method that can learn communication capacity and eliminate the need to change the contents of countermeasures for blind zones after the setting of a repeater apparatus.

### Solution to Problem

A communication capacity evaluating apparatus according to the present invention is a communication capacity evaluating apparatus that evaluates communication capacity of communication using a multiple-input and multiple-output scheme, and employs a configuration to include an acquiring section that acquires band information for use of communication using the multiple-input and multiple-output scheme from a received signal, and analyzes the received signal to calculate a signal-to-noise ratio and a channel matrix; a limit value calculating section that calculates a limit value of communication capacity based on the band information for use, the signal-to-noise ratio, the channel matrix, the number of transmitting antennas of a communication party, and the number of receiving antennas; and a display section that displays a comparison result between the limit value and a desired value of communication capacity set in advance.

A radio repeater apparatus according to the present invention is a radio repeater apparatus that performs relay processing of communication using a multiple-input and multiple-output scheme, and that employs a configuration to include an acquiring section that acquires band information for use of communication using the multiple-input and multiple-output scheme from a received signal, and analyzes the received signal to calculate a signal-to-noise ratio and a channel matrix; a limit value calculating section that calculates a limit value of communication capacity based on the band information for use, the signal-to-noise ratio, the channel matrix, the number of transmitting antennas of a communication party, and the number of receiving antennas; and a display section that displays a comparison result between the limit value and a desired value of communication capacity set in advance.

A communication capacity evaluating method according to the present invention is a method for evaluating communication capacity of communication using a multiple-input and multiple-output scheme, and employs the steps of acquiring band information for use of communication using the multiple-input and multiple-output scheme from. a received signal, and analyzing the received signal to calculate a signal-to-noise ratio and a channel matrix; calculating a limit value of communication capacity based on the band information for use, the signal-to-noise ratio, the channel matrix, the number of transmitting antennas of a communication party, and the number of receiving antennas; and displaying a comparison result between the limit value and a desired value of communication capacity set in advance.

### Advantageous Effects of Invention

According to the present invention, it is possible to learn communication capacity and eliminate the need to change the contents of countermeasures for blind zones after the setting of a repeater apparatus.

### BRIEF DESCRIPTION OF DRAWINGS

FIG. 1 is a block diagram showing the configuration of a radio repeater apparatus according to Embodiment 1 of the present invention;

FIG. 2 illustrates a method of calculating a channel matrix between a base station and a radio repeater apparatus according to Embodiment 1 of the present invention;

FIG. 3 is a block diagram showing the configuration of a radio repeater apparatus according to Embodiment 2 of the present invention;

FIG. 4 illustrates a relationship between a limit value of communication capacity and an eigenvalue upon changing the eigenvalue in a case where the number of antennas according to Embodiment 2 of the present invention are two in transmission and reception; and

FIG. 5 is a block diagram showing the configuration of a communication capacity evaluating apparatus according to Embodiment 3 of the present invention.

### DESCRIPTION OF EMBODIMENTS

Now, embodiments of the present invention will be described in detail with reference to the accompanying drawings.

### Embodiment 1

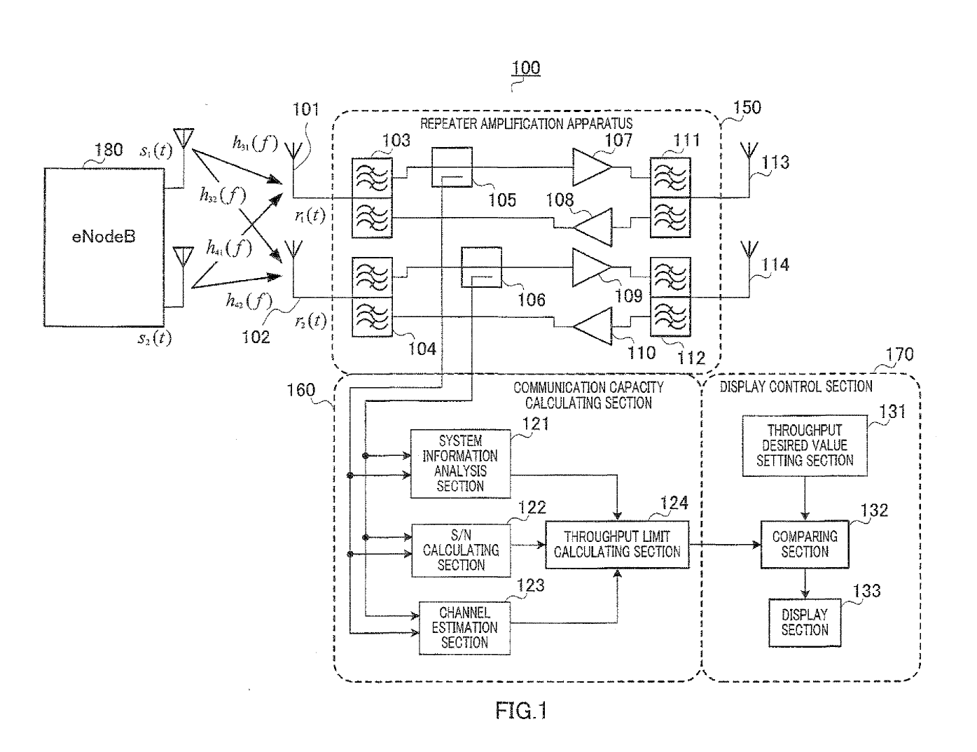

FIG. 1 is a block diagram showing the configuration of radio repeater apparatus 100 according to Embodiment 1 of the present invention.

Radio repeater apparatus 100 mainly has repeater amplification apparatus 150, communication capacity calculating section 160, and display control section 170.

Repeater amplification apparatus 150 receives signals transmitted from base station 180 using a MIMO scheme, and amplifies and transmits the received signals to communication terminal apparatuses (not shown) or other repeater apparatuses (not shown). Also, in communication using a MIMO scheme, repeater amplification apparatus 150 receives and amplifies signals transmitted from communication terminal apparatuses (not shown) or other repeater apparatuses (not shown) using a MIMO scheme, and transmits the amplified signals to base station 180. That is to say, repeater amplification apparatus 150 performs relay processing of signals in communication using a MIMO scheme.

Communication capacity calculating section 160 calculates a limit value of communication capacity of signals in which repeater amplification. apparatus 150 receives from base station 180, and outputs the calculated limit value to display control section 170.

Display control section 170 calculates a desired value of communication capacity based on a calculating result of a limit value of communication capacity input from communication capacity calculating section 160, and performs control to display a comparison result between the limit value and the desired value.

Next, a detailed configuration of repeater amplification apparatus 150 will be described with reference to FIG. 1.

Repeater amplification apparatus 150 is mainly formed with first antenna 101, second antenna 102, filter 103, filter 104, demultiplexing section 105, demultiplexing section 106, amplifier 107, amplifier 108, amplifier 109, amplifier 110, filter 111, filter 112, third antenna 113, and fourth antenna 114.

First antenna 101 receives signals transmitted from base station 180 and outputs the signals to filter 103. Also, first antenna 101 transmits signals input from filter 103 to base station 180.

Second antenna 102 receives signals transmitted from base station 180 and outputs the signals to filter 104, Also, second antenna 102 transmits signals input from filter 104 to base station 180, Here, first antenna 101 and second antenna 102 are used for performing communication using a MIMO scheme.

Filter 103 performs band limitation to signals input from first antenna 101 and outputs the signals to demultiplexing section 105. Also, filter 103 performs band limitation to signals input from amplifier 108 and outputs the signals to first antenna 101.

Filter 104 performs band limitation to signals input from second antenna 102 and. outputs the signals to demultiplexing section 106. Filter 104 performs band limitation to signals input from amplifier 110 and outputs the signals to second antenna 102,

Demultiplexing section 105 demultiplexes signals input from filter 103 and outputs the demultiplexed signals to amplifier 107, system information analysis section 121, S/N calculating section 122, and channel estimation section 123.

Demultiplexing section 106 demultiplexes signals input from filter 104 and outputs the demultiplexed signals to amplifier 109, system information analysis section 121, S/N calculating section 122, and channel estimation section 123.

Amplifier 107 amplifies signals input from demultiplexing section 105 and outputs the signals to filter 111.

Amplifier 108 amplifies signals input from filter 111 and outputs the signals to filter 103.

Amplifier 109 amplifies signals input from demultiplexing section 106 and outputs the signals to filter 112,

Amplifier 110 amplifies signals input from filter 112 and outputs the signals to filter 104.

Filter 111 performs band limitation to signals input from amplifier 107 and outputs the signals to third antenna 113. Also, filter 111 performs band limitation to signals input from third antenna 113 and outputs the signals to amplifier 108.

Filter 112 performs band limitation to signals input from amplifier 109 and outputs the signals to fourth antenna 114. Also, filter 112 performs band limitation to signals input from fourth antenna 114 and outputs the signals to amplifier 110.

Third antenna 113 transmits signals input from filter 111 to communication terminal apparatuses (not shown) or other repeater apparatuses (not shown). Also, third antenna 113 outputs signals received from communication terminal apparatuses (not shown) or other repeater apparatuses (not shown) to filter 111.

Fourth antenna 114 transmits signals input from filter 112 to communication terminal apparatuses (not shown) or other repeater apparatuses (not shown). Also, fourth antenna 114 outputs signals received from communication terminal apparatuses (not shown) or other repeater apparatuses (not shown) to filter 112.

Next, a detailed configuration of communication capacity calculating section 160 will be described with reference to FIG. 1.

Communication capacity calculating section 160 is mainly formed with system information analysis section 121, S/N calculating section 122, channel estimation section 123, and throughput limit calculating section 124. System information analysis section 121, S/N calculating section 122, and channel estimation section 123 form an acquiring section that acquires band information for use, and acquires communication quality and a channel matrix.

System information analysis section 121 analyzes signals input from demultiplexing section 105 and demultiplexing section 106. System information analysis section 121 acquires band information for use (BW) in communication using a MIMO scheme and information about the number of transmitting antennas of base station 180, Also, system information analysis section 121 outputs the acquired band information for use and information about the number of transmitting antennas to throughput limit calculating section 124.

SIN calculating section 122 analyzes known pilot signals input from demultiplexing section 105 and demultiplexing section 106 to calculate a S/N ratio (a signal-to-noise ratio). S/N calculating section 122 outputs the calculating result of the S/N ratio to throughput limit calculating section 124.

Channel estimation section 123 analyzes known pilot signals input from demultiplexing section 105 and demultiplexing section 106, and estimates a channel matrix (a transfer function) between transmitting antennas of base station 180, and first antenna 101 and second antenna 102. Channel estimation section 123 outputs the estimation result of the channel matrix to throughput limit calculating section 124.

Throughput limit calculating section 124 calculates a limit value of communication capacity based on band information for use and information about the number of transmitting antennas, which are input from system information analysis section 121, previously stored information about the number of receiving antennas of radio repeater apparatus 100, a calculating result of a S/N ratio input from S/N calculating section 122, and an estimation result of a channel matrix input from channel estimation section 123. Throughput limit calculating section 124 outputs the calculating result of a limit value to comparing section 132. Here, a method for calculating a throughput limit value will be described later.

Next, a detailed configuration of display control section 170 will be described with reference to FIG. 1.

Display control section 170 is mainly formed with throughput desired value setting section 131, comparing section. 132, and display section 133.

Throughput desired value setting section 131 sets a desired value and an allowable range in advance. Here, the above setting is performed by users (for example, telecommunication carriers).

Comparing section 132 compares a limit value input from throughput limit calculating section 124 with a desired value input from throughput desired value setting section 131, and outputs the comparison result to display section 133.

Display section 133 displays a comparison result input from comparing section 132. Display section 133, for example, can display a comparison result by the number of antenna bars according to a difference between a limit value and a desired value. Also, display section 133 can display a comparison result by color according to a difference between a limit value and a desired value. Upon the display of a comparison result by color, for example, it is possible to display all or part of a display screen in red in a case where a difference between a limit value and a desired value is equal to or greater than a threshold, and to display all or part of a display screen in green in a case where a difference between a limit value and a desired value is less than a threshold. The display of a comparison result can be performed by no means limited to the number of antenna bars and color, but performed by any method.

Next, a method of calculating a limit value of communication capacity in radio repeater apparatus 100 will be described. According to the present embodiment, communication based on long term evolution (LTE) which is one of next-generation communication schemes will be described as an example. A communication scheme is not limited to LTE, but appropriately changeable.

System information analysis section 121 demodulates a physical broadcast channel (PBCH) in a LTE downlink signal, acquires a master information block (MIB), and analyzes acquired MIB. System information analysis section 121 analyzes a MIB, and acquires band information for use in a system and information about the number of transmitting antennas, which are stored in the MIB, so that it is possible to learn bandwidth for use and the number of transmitting antennas. System information analysis section 121 can eliminate the need to acquire information about the number of transmitting antennas in a case where the number of transmitting antennas of radio repeater apparatus 100 is already known between base station 180 and radio repeater apparatus 100. In this case, the number of transmitting antennas is previously stored in a memory (not shown) and the like, as with the information about the number of receiving antennas.

Also, S/N calculating section 122 calculates a S/N ratio by analyzing known pilot signals embedded in received signals. For example, as shown in equation 1, S/N calculating section 122 calculates a difference between adjacent pilot signals to calculate an ensemble average of the calculated deference. By this means, S/N calculating section 122 can calculate noise component σ.

$$\begin{matrix}( Equation 1 ) & \\ {σ}^{2} = \frac{1}{N - 1} {\sum }_{n = 0}^{N - 1} {\vert {P}_{N + 1} - {P}_{n} \vert}^{2} & [ 1 ]\end{matrix}$$

Also, as shown. equation 2, S/N calculating section 122 adds adjacent pilot signals and calculates an ensemble average of the addition result. S/N calculating section 122 calculates signal component S by dividing an ensemble average of the addition result by noise component n calculated from equation 1.

$$\begin{matrix}( Equation 2 ) & \\ {S}^{2} = \frac{1}{N - 1} {\sum }_{n = 0}^{N - 1} {\vert {P}_{N + 1} + {P}_{n} \vert}^{2} - {σ}^{2} & [ 2 ]\end{matrix}$$

Also, S/N calculating section 122 calculates a S/N ratio by calculating a ratio between signal component S calculated from equation 2 and noise component calculated from equation 1.

Also, channel estimation section 123 estimates a channel matrix (a transfer function) between a plurality of transmitting antennas of base station 180, and first antenna 101 and second antenna 102 by analyzing known signals embedded in received signals.

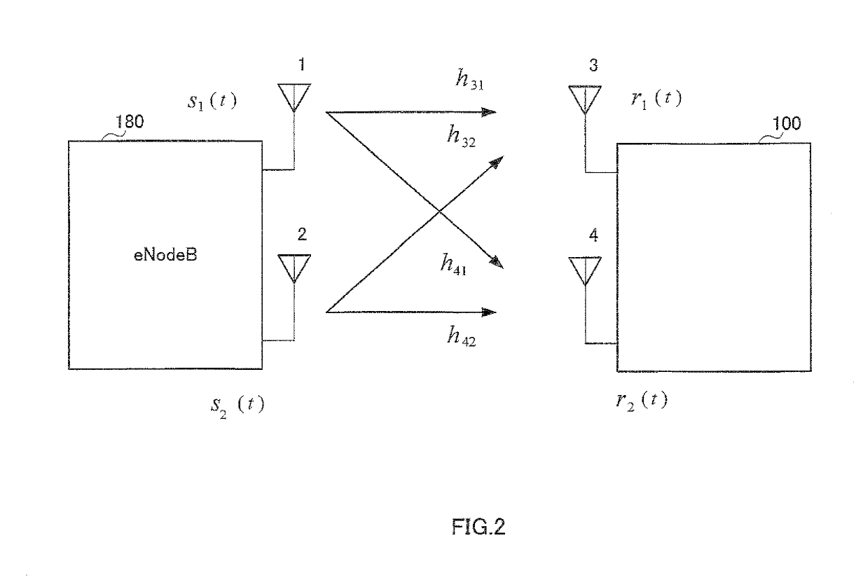

Also, a channel matrix between base station 180 and radio repeater apparatus 100 can be calculated by the following method in channel estimation section 123. FIG. 2 illustrates a method of calculating a channel matrix between base station 180 and radio repeater apparatus 100.

In the case of receiving signals transmitted from a plurality of antennas by a plurality of antennas, received signals arc represented by equation 3.

[Equation 3]

R=HS (3)

Here, R: received signal

S: transmission signal

H: channel matrix (transfer function)

Also, equation 3 can be represented by equation 4 according to FIG. 2.

$$\begin{matrix}( Equation 4 ) & \\ [ \begin{matrix}{r}_{1} ( t ) \\ {r}_{2} ( t )\end{matrix} ] = [ \begin{matrix}{h}_{31} & {h}_{32} \\ {h}_{41} & {h}_{42}\end{matrix} ] [ \begin{matrix}{s}_{1} ( t ) \\ {s}_{2} ( t )\end{matrix} ] & [ 4 ]\end{matrix}$$

Here, a pilot signal is targeted for analysis, and therefore, it is possible to calculate channel matrix H by dividing a received signal by a pilot signal as in equation 5.

[Equation 5]

H=RS⁻¹ (5)

Here, R: received signal

S: transmission signal

H: channel matrix (transfer function)

Throughput limit calculating section 124 calculates a limit value of communication capacity based on a channel matrix calculated by the above-described method, band information for use, information about the number of transmitting antennas, information about the number of receiving antennas, and the S/N ratio calculating result.

Specifically, throughput limit calculating section 124 calculates channel capacity (a throughput limit value) per unit frequency from equation 6.

$$\begin{matrix}( Equation 6 ) & \\ \begin{matrix}{C}_{OFDM} = \frac{1}{N} {\sum }_{k = 0}^{N - 1} log det [ {I}_{Nl} + ρ {H}^{H} ( k ) H ( k ) ] \\ = \frac{1}{N} {\sum }_{k = 0}^{N - 1} [ {\sum }_{i = 0}^{min ( {N}_{tx} , {N}_{rx} ) - 1} log ( 1 + {ρλ}_{i ( k )} ) ]\end{matrix} & [ 6 ]\end{matrix}$$

Here, k: subcarrier index (total number N)

I_{Nt}: N₁×Nₜ identity matrix

Nᵣₓ: the number of receiving antenna

Nₜₛ: the number of transmitting antenna

H: Nᵣₛ×Nᵢₛ channel matrix

p: SNR per one antenna

λᵢ₍ₖ₎: i th eigenvalue of H^{H} (k)H(k)

That is to say, throughput limit calculating section 124 calculates throughput using a matrix eigenvalue which can be calculated from a channel matrix. In the case of OFDM transmission, throughput limit calculating section 124 calculates throughput per subcarrier and calculates an average of all subcarriers using the calculated throughput, thereby calculating throughput limit value.

Also, throughput limit calculating section 124 calculates a throughput limit value in transmission bandwidth by multiplying the throughput limit value calculated from equation 6 by bandwidth for use in the system.

As described above, according to the present embodiment, it is possible to learn communication capacity, and eliminate the need to change the contents of countermeasures for blind zones after the setting of a repeater apparatus by determining whether or not a limit value of desired communication capacity is satisfied.

### Embodiment 2

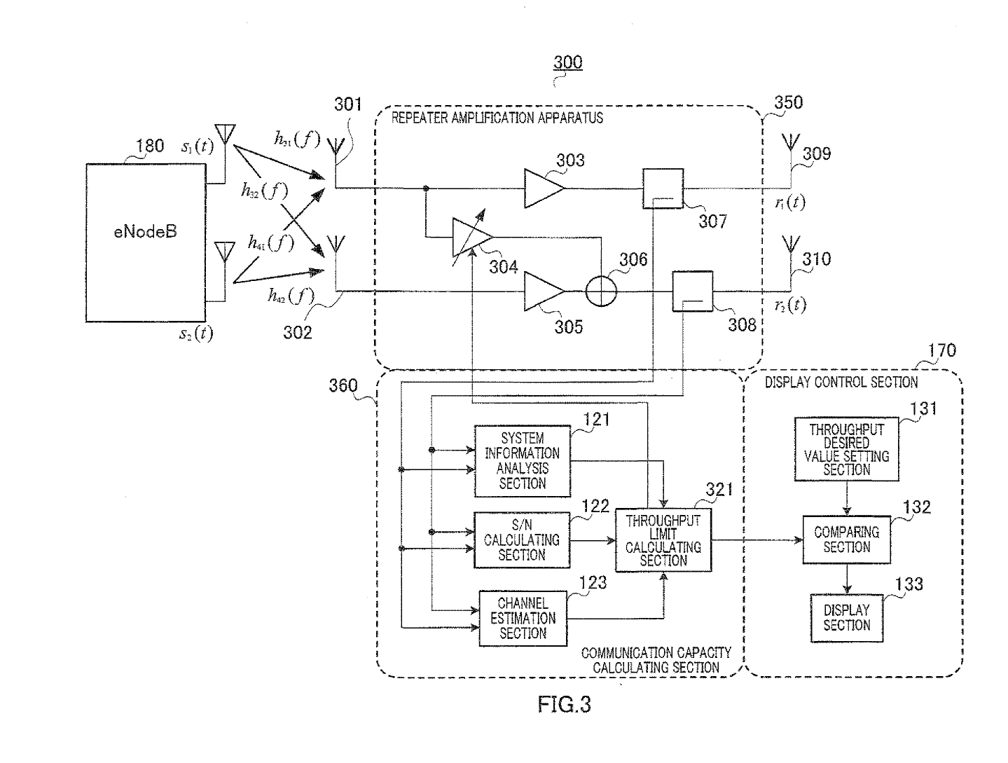

FIG. 3 is a block diagram showing the configuration of radio repeater apparatus 300 according to Embodiment 2 of the present invention.

In contrast to radio repeater apparatus 100 according to Embodiment 1 shown in FIG. 1, radio repeater apparatus 300 shown in FIG. 3 has repeater amplification apparatus 350 instead of repeater amplification apparatus 150 and has communication capacity calculating section 360 instead of communication capacity calculating section 160. Here, in FIG. 3, parts that are the same configuration as in FIG. 1 will be assigned the same reference numerals as in FIG. 1.

In communication using a MIMO scheme, repeater amplification apparatus 350 receives signals transmitted from base station 180, amplifies the received signals, and transmits the amplified signals to communication terminal apparatuses (not shown) or other repeater apparatuses (not shown). That is to say, repeater amplification apparatus 350 performs relay processing of signals in communication using a MIMO scheme. Also, repeater amplification apparatus 350 sets a variable gain by control of communication capacity calculating section 360 and amplifies signals.

Communication capacity calculating section 360 calculates a limit value of communication on capacity of signals in which repeater amplification apparatus 350 receives from base station 180, and outputs the calculated limit value to display control section 170. Also, communication capacity calculating section 360 adjusts a gain upon amplifying signals in repeater amplification apparatus 350.

Display control section 170 performs control to display a comparison result between a limit value and a desired value of communication capacity, based on a calculating result of communication capacity input from communication capacity calculating section 360.

Next, a detailed configuration of repeater amplification apparatus 350 will be described with reference to FIG. 3.

Repeater amplification apparatus 350 is mainly formed with first antenna 301, second antenna 302, amplifier 303, variable amplifier 304, amplifier 305, adder 306, demultiplexing section 307, demultiplexing section 308, third antenna 309, and fourth antenna 310. Amplifier 303 and amplifier 305 form an amplification section that amplifies signals received from first antenna 301 and signals received from second antenna 302.

First antenna 301 receives signals transmitted from base station 180 and outputs the signals to amplifier 303 and variable amplifier 304.

Second antenna 302 receives signals transmitted from base station 180 and outputs the signals to amplifier 305.

Amplifier 303 amplifies signals input from first antenna 301 and outputs the signals to demultiplexing section 307.

Variable amplifier 304 sets a predetermined gain by control of throughput limit calculating section 321. Also, variable amplifier 304 amplifies signals input from first antenna 301 by the set gain and outputs the amplified signals to adder 306. That is to say, variable amplifier 304 amplifies signals by a variable gain. A Method of adjusting a gain in variable amplifier 304 will be described later,

Amplifier 305 amplifies signals input from second antenna 302 and outputs the amplified signals to adder 306.

Adder 306 adds signals input from variable amplifier 304 and signals input from amplifier 305, and outputs the added signals to demultiplexing section 308.

Demultiplexing section 307 demultiplexes signals input from amplifier 303 and outputs the demultiplexed signals to third, antenna 309, system information, analysis section 121, S/N calculating section 122, and channel estimation section 123.

Demultiplexing section 308 demultiplexes signals input from adder 306 and outputs the demultiplexed signals to fourth antenna 310, system information analysis section 121, S/N calculating section 122, and channel estimation section 123.

Third antenna 309 transmits signals input from demultiplexing section 307 to communication terminal apparatuses (not shown) or other repeater apparatuses (not shown).

Fourth antenna 310 transmits signals input from demultiplexing section 308 to communication terminal apparatuses (not shown) or other repeater apparatuses (not shown).

Next, a detailed configuration of communication capacity calculating section 360 will be described with reference to FIG. 3.

In contrast to communication capacity calculating section 160 according to Embodiment 1 shown in FIG. 1, communication capacity calculating section 360 shown in FIG. 3 has throughput limit calculating section 321 instead of throughput limit calculating section 124. Here, in FIG. 3, parts that are the same configuration as in FIG. 1 will be assigned the same reference numerals as in FIG. 1 and therefore an explanation thereof will be omitted.

Communication capacity calculating section 360 is mainly formed with system information analysis section 121, S/N calculating section 122, channel estimation section 123, and throughput limit calculating section 321.

System information analysis section 121 analyzes signals input from demultiplexing section 307 and demultiplexing section 308. System information analysis section 121 acquires band information for use in communication using a MIMO scheme and information about the number of transmitting antennas of base station 180. Also, system information analysis section 121 outputs acquired band information for use and information about the number of transmitting antennas to throughput limit calculating section 321. System information analysis section 121 can eliminate the need to acquire information about the number of transmitting antennas in a case where the number of transmitting antennas is already known between base station 180 and radio repeater apparatus 100. In this case, the number of transmitting antennas is stored in a memory (not shown) and the like in advance, as with information about the number of receiving antennas of radio repeater apparatus 300.

S/N calculating section 122 analyzes known pilot signals input from demultiplexing section 307 and demultiplexing section 308 to calculate a S/N ratio (a signal-to-noise ratio). At this time, S/N calculating section 122 amplifies signals by a gain adjusted in throughput. limit calculating section 321, and calculates a S/N ratio using the signals amplified in variable amplifier 304. S/N calculating section 122 outputs the calculating result of the S/N ratio to throughput limit calculating section 321.

Channel estimation section 123 analyzes known pilot signals input from demultiplexing section 307 and demultiplexing section 308, and estimates a channel matrix (a transfer function) between transmitting antennas of base station 180, and first antenna 301 and second antenna 302. Channel estimation section 123 outputs the estimation result of the channel matrix to throughput limit calculating section 321.

Throughput limit calculating section 321 calculates a limit value of communication capacity based on band information for use and information about the number of transmitting antennas, which are input from system information analysis section 121, information about the number of receiving antennas of radio repeater apparatus 100, a calculating result of the S/N ratio input from S/N calculating section 122, and an estimation result of the channel matrix input from channel estimation section 123. Also, throughput limit calculating section 321 adjusts a gain of variable amplifier 304 such that the calculated limit value is optimal. Also, throughput limit calculating section 321 outputs the calculating result of the limit value to comparing section 132. Also, a method of calculating a throughput limit value is the same as in above Embodiment 1, and therefore an explanation thereof will be omitted.

Comparing section 132 compares a limit value input from throughput limit calculating section 321 with a desired value input from throughput desired. value setting section 131, and outputs the comparison result to display section 133.

Next, an operation of channel estimation section 123 and throughput limit calculating section 321 will be described.

Throughput limit calculating section 321 can change a channel matrix to be estimated in channel estimation section 123, by changing a gain of variable amplifier 304. By this means, communication capacity can be improved.

Specifically, the above equation 4 is represented by equation 7 by changing a gain of variable amplifier 304. A of equation 7 is a fixed value (for example, users can set this value), and A′ and B are variables. When B=0, A=A′, equation 7 is the same as equation 4 in case of receiving signals by simply two antennas. From this state, it is possible to change a state of equation 4 by increasing B and decreasing A′ such that A′ is equal to output power of radio repeater apparatus 300. A of Equation 7 may be determined, for example, based on path loss between base station 180 and radio repeater apparatus 300.

$$\begin{matrix}( Equation 7 ) & \\ [ \begin{matrix}{r}_{1} ( t ) \\ {r}_{2} ( t )\end{matrix} ] = [ \begin{matrix}{Ah}_{31} & {Ah}_{32} \\ {A}^{′} {h}_{41} \pm {Bh}_{31} & {A}^{′} {h}_{42} \pm {Bh}_{32}\end{matrix} ] [ \begin{matrix}{s}_{1} ( t ) \\ {s}_{2} ( t )\end{matrix} ] + Z ( t ) & [ 7 ]\end{matrix}$$

Accordingly, channel estimation section 123 calculates a channel matrix from equation 7.

That is to say, the change of a gain of variable amplifier 304 is equivalent to the operation of a channel matrix, and also equivalent to the change of an eigenvalue of equation 6.

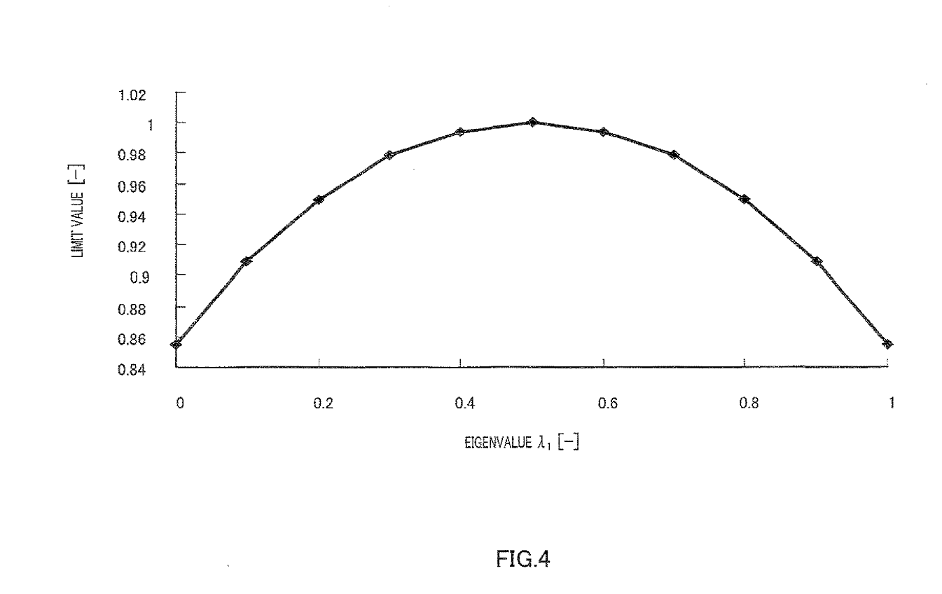

FIG. 4 illustrates a relationship between a limit value and eigenvalue of communication capacity in the case of changing eigenvalue λ₁ of equation 6, in a case where the number of antennas is two in transmission and reception. In FIG. 4, the vertical axis is a limit value of communication capacity and the horizontal axis is an eigenvalue.

As shown in FIG. 4, throughput limit calculating section 321, for example, adjusts a gain set in variable amplifier 304 such that a limit value of communication capacity is the highest, and acquires an effect to improve communication capacity.

As described above, according to the present embodiment, in addition to the effect in the above-described Embodiment 1, since a cause to degrade a limit value of communication capacity is cancelled by varying a gain and correcting an eigenvalue, therefore, it is possible to prevent the decrease in communication capacity.

In the present embodiment, although the radio repeater apparatus performs relay processing of only signals received from a base station, the present embodiment is not limited to this, but the radio repeater apparatus may perform relay processing of signals transmitted to the base station. In this case, as with FIG. 1, it is possible to demultiplex transmission signals and received signals by providing a band limitation filter immediately beneath an antenna.

### Embodiment 3

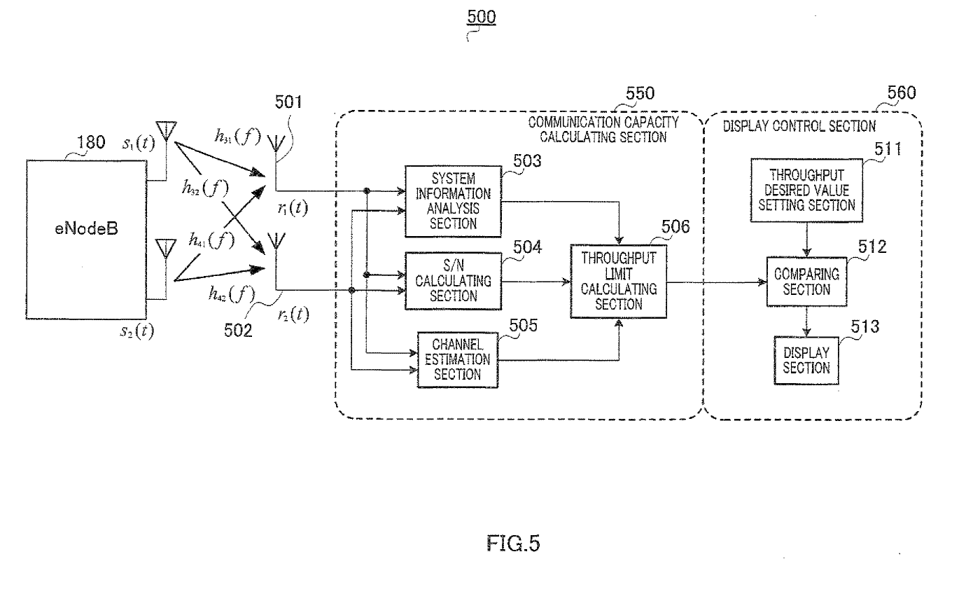

FIG. 5 is a block diagram showing the configuration of communication capacity evaluating apparatus 500 according to Embodiment 3 of the present invention.

Communication capacity evaluating apparatus 500 is mainly formed with communication capacity calculating section 550 and display control section 560.

Communication capacity calculating section 550 calculates a limit value of communication capacity in a MIMO scheme using signals received from base station 180 and outputs the calculated signals to display control section 560.

Display control section 560 calculates a desired value of communication capacity based on a calculating result of a limit value of communication capacity input from communication capacity calculating section 550, and performs control to display a comparison result between a limit value and a desired value.

Next, a detailed configuration of communication capacity calculating section 550 will he described with reference to FIG. 5.

Communication capacity calculating section 550 is mainly formed with first antenna 501, second. antenna 502, system information analysis section 503, S/N calculating section 504, channel estimation section 505, and throughput limit calculating section 506. System information analysis section 503, S/N calculating section 504, and channel estimation section 505 form an acquiring section that acquires band information for use and acquires communication quality and a channel matrix.

First antenna 501 receives signals transmitted from base station 180 and outputs the signals to system information analysis section 503, S/N calculating section 504, and channel estimation. section 505.

Second antenna 502 receives signals transmitted from base station 180 and outputs the signals to system information analysis section 503, S/N calculating section 504, and channel estimation section 505.

System information analysis section 503 analyzes signals input from first antenna 501 and second antenna 502. System information analysis section 503 acquires band information for use in communication using a MIMO scheme and information about the number of transmitting antennas of base station 180. System information analysis section 503 outputs the acquired band information for use and information about the number of transmitting antennas to throughput limit calculating section 506. System information analysis section 503 can eliminate the need to acquire information about the number of transmitting antennas in a case where the number of transmitting antennas is already known between base station 180 and communication capacity evaluating apparatus 500. In this case, the number of transmitting antennas is stored in a memory (not shown) and the like in advance, as with information about the number of receiving antennas of communication capacity evaluating apparatus 500.

S/N calculating section 504 analyzes known pilot signals input from first antenna 501 and second antenna 502 to calculate a S/N ratio (a signal-to-noise ratio). S/N calculating section 504 outputs the calculating result of the S/N ratio to throughput limit calculating section 506.

Channel estimation section 505 analyzes known pilot signals input from first antenna 501 and second antenna 502, and estimates a channel matrix (a transfer function) between transmitting antennas of base station 180, and first antenna 501 and second antenna 502. Channel estimation section 505 outputs the estimation result of the channel matrix to throughput calculating section 506.

Throughput limit calculating section 506 calculates a limit value of communication capacity based on band information for use and information about the number of transmitting antennas, which are input from system information analysis section 503, information about the number of receiving antennas of communication capacity evaluating apparatus 500, a calculating result of the S/N ratio input from S/N calculating section 504, and an estimation result of the channel matrix input from channel estimation section 505. Throughput limit calculating section 506 outputs the calculating result of a limit value to comparing section 512. Also, a method of calculating a throughput limit value is the same as in above Embodiment 1, and therefore an explanation thereof will be omitted.

Next, a detailed configuration of display control section 560 will be described with reference to FIG. 5.

Display control section 560 is mainly formed with throughput desired value setting section 511 and comparing section 512, and display section 513.

Throughput desired value setting section 511 sets a desired value and an allowable range in advance.

Comparing section 512 compares a limit value input from throughput limit calculating section 506 with a desired value input from throughput desired value setting section 511, and outputs the comparison result to display section 513.

Display section 513 displays a comparison result input from comparing section 512. Display section 513, for example, can display a comparison result by the number of antenna bars according to a difference between a limit value and a desired value. Also, display section 513 can display a comparison result by color according to a difference between a limit value and a desired value. Upon the display of a comparison result by color, for example, it is possible to display all or part of a display screen in red in a case where a difference between a limit value and a desired value is equal to or greater than a threshold, and to display all or part of a display screen in green in a case where a difference between a limit value and a desired value is less than a threshold. The display of a comparison result can be performed by no means limited to the number of antenna bars and color, but performed by any method.

As described above, according to the present embodiment, it is possible to learn communication capacity, and eliminate the need to change the contents of countermeasures for blind zones after the setting of a repeater apparatus by determining whether or not a limit value of desired communication capacity is satisfied. Also, according to the present embodiment, since communication capacity is calculated by a communication capacity evaluating apparatus which is separately provided from a radio repeater apparatus, therefore, manufacturing cost of a radio repeater apparatus can be reduced compared to a case where a communication capacity evaluating apparatus is provided in a radio repeater apparatus.

In the above Embodiment 1 to Embodiment 3, although each of the number of antennas of a base station, a radio repeater apparatus, and a communication capacity evaluating apparatus is two, the present invention is not limited to this, it is equally possible to set any number of antennas equal to or greater than three.

The disclosures of Japanese Patent Application No. 2009-260222, filed on Nov. 13, 2009, including the specifications, drawings and abstracts, are incorporated herein by reference in their entirety.

### INDUSTRIAL APPLICABILITY

A communication capacity evaluating apparatus, a radio repeater apparatus, and a communication capacity evaluating method according to the present invention are particularly suitable for learning communication capacity in a setting location of a radio repeater apparatus which performs relay processing of communication using a MIMO scheme.

1-5. (canceled)

6. A communication capacity evaluating apparatus for evaluating communication capacity of communication using a multiple-input and multiple-output scheme comprising:
an acquiring section that acquires band information for use of communication using the multiple-input and multiple-output scheme, and. information about the number of transmitting antennas from a received signal, and analyzes the received signal to calculate a signal-to-noise ratio and a channel matrix;
a limit value calculating section that calculates a limit value of communication capacity based on the band information for use, the signal-to-noise ratio, the channel matrix, the acquired number of transmitting antennas, and the number of receiving antennas; and
a display section that displays a comparison result between the limit value and a desired value of communication capacity set in advance.

7. A radio repeater apparatus for performing relay processing of communication using a multiple-input and multiple-output scheme comprising:
an acquiring section that acquires band information for use of communication using the multiple-input and multiple-output scheme, and information about the number of transmitting antennas from a received signal, and analyzes the received signal to calculate a signal-to-noise ratio and a channel matrix;
a limit value calculating section that calculates a limit value of communication capacity based on the band information for use, the signal-to-noise ratio, the channel matrix, the acquired number of transmitting antennas, and the number of receiving antennas; and
a display section that displays a comparison result between the limit value and a desired value of communication capacity set in advance.

8. The radio repeater apparatus according to claim 7 further comprising:
a first antenna;
a second antenna;
a first amplification section that amplifies a signal received by the first antenna and a signal received by the second antenna;
a second amplification section that amplifies the signal, which is received by the first antenna, using a variable gain; and
an adding section that adds the signal amplified by the second amplification section to the received signal of the first antenna amplified by the first amplification section to output the added signal,
wherein the acquiring section analyzes the received signal of the first antenna amplified by the first amplification section and the output signal of the adding section, and calculates the channel matrix.

9. The radio repeater apparatus according to claim 8, wherein the limit value calculating section sets to the second amplification section, a gain such that the limit value is optimal.

10. A method for evaluating communication capacity of communication using a multiple-input and multiple-output scheme, the method comprising the steps of:
acquiring band information for use of communication using the multiple-input and multiple-output scheme, and information about the number of transmitting antennas from a received signal, and analyzing the received signal to calculate a signal-to-noise ratio and a channel matrix;
calculating a limit value of communication capacity based on the band information for use, the signal-to-noise ratio, the channel matrix, the acquired number of transmitting antennas, and the number of receiving antennas; and
displaying a comparison result between the limit value and a desired value of communication capacity set in advance.
